(19) United States
(12) Patent Application Publication
(10) Pub. No.: US 2013/0077027 A1
(43) Pub. Date: Mar. 28, 2013

(54) LED ARRAYS

(71) Applicants: Neil Griffin, Cambridge (GB); Neil Pollock, Royston (GB)

(72) Inventors: Neil Griffin, Cambridge (GB); Neil Pollock, Royston (GB)

(21) Appl. No.: 13/637,123

(22) PCT Filed: Mar. 25, 2011
(86) PCT No.: PCT/GB2011/050605

§ 371 Date: Dec. 4, 2012

(30) Foreign Application Priority Data
Mar. 26, 2010 (GB) 1005109.2

(51) Int. Cl. G02F 1/1335; F21V 8/00

(52) U.S. Cl. CPC G02F 1/133615; G02B 6/0011
USPC 349/65; 362/612

(57) ABSTRACT

This invention relates to structures for mounting LEDs, said structures being suitable for use in the manufacture of light guide devices. This invention also relates to light guide devices comprising said structures and methods of manufacture of the aforementioned. The light guide devices are suitable for use in a range of applications, particularly in connection with the backlighting of displays, for example, liquid crystal displays.

### FIELD OF THE INVENTION

This invention relates to edge-lit light guide devices and LED assemblies, said assemblies being suitable for use in the manufacture of light guide devices. This invention also relates to light guide devices comprising said assemblies and methods of manufacture of the aforementioned. The light guide devices are suitable for use in a range of applications, particularly in connection with the backlighting of displays including liquid crystal displays.

### BACKGROUND OF THE INVENTION

A number of light guiding devices are known. These devices are employed for a range of functions including illumination, backlighting, signage and display purposes. Typically, the devices are constructed from a moulded or cast transparent plastic component, where a light source, such as a fluorescent lamp or a plurality of light emitting diodes (LEDs), is integrated by means of mechanical attachment at the edge of the transparent plastic component.

Common to all of these devices is the fact that light from the light source is guided through a transparent guide, typically made of plastic, by total internal reflection. For backlighting applications, light is emitted in a substantially perpendicular direction to that of the direction of propagation of the light within the transparent guide. This may be achieved through the light being directed so as to interact with scattering structures located within, or on the surface of, the transparent guide.

The integration of fluorescent lamps or LEDs to the edge of the transparent light guide is not a straightforward process and thus significantly increases the complexity of the production process for these devices. Achieving a good coupling of the light source and the light guide is essential to the optical performance of the device. In addition, edge coupling of the light sources may render these components susceptible to mechanical damage during both the production process and the normal use of the device.

Many backlights fall into the categories of “edge-lit” or “direct-lit”. These categories differ in the placement of the light sources relative to the output of the backlight, where the output area defines the viewable area of the display device. In edge-lit backlights, one or more light sources are disposed along an outer border or edge of the backlight construction outside the zone corresponding to the output area. The light sources typically emit light into a light guide, which has length and width dimensions of the order of the output area and from which light is extracted to illuminate the output area. In direct-lit backlights, an array of light sources is disposed directly behind the output area, and a diffuser is placed in front of the light sources to provide a more uniform light output. Some direct-lit backlights also incorporate an edge-mounted light, and are thus illuminated with a combination of direct-lit and edge-lit illumination.

FIG. 1 illustrates a known edge-lit light guide arrangement. LEDs (1) are arranged at the edge of a transparent polymer core light guide layer (2). Light (3) from the LEDs propagates by total internal reflection through the light guide layer and is scattered through approximately 90° by scattering structures, such as point like defects, (4) and exits (3a) the light guide layer. In the figure shown, the device is viewed from above as indicated; the main light output surface is indicated at (5) and the point like defects (4) are located on the opposite lower surface. The refractive index contrast between the core and surrounding air provides the guiding effect. Light scattered out of this type of structure is emitted from the top surface over a full hemisphere of output angles.

The use of LEDs in backlight units is becoming increasingly popular. A standard LED package generally includes a hard plastic protecting material which supplies a high degree of mechanical stability to a lead frame structure. The lead frame possesses first and second terminals referred to as the die attach lead and the isolated lead by which electrical power is supplied to the LED package. The single LED may be connected to both leads by wire bonds. In operation, the LED package assembly has power applied to the lead frame at either of the first and second terminals depending on which part of the LED is the anode and which part is the cathode. The plastic protecting material allows for the manipulation and bending of the lead frame leads for solder configuration. Various polymers have been used by various manufacturers as the protecting material in connection with the packaging of LED products. However, methods for protecting the LED die are limited because of the relatively fragile nature of the wire-bonded lead frame arrangement. The hard plastic protecting material is normally applied using a resin-transfer process using optical resins rather than pure polymers. Resin transfer is a low pressure process that has a low risk of damaging wire bonds. Most protecting materials used for LED production have very high refractive indices resulting in a high proportion of the light generated by the LED die being reflected back in to the material at the material/air surface interface.

Arrays of LEDs are conventionally mounted onto rigid printed circuit boards (PCBs) or ceramic substrates with metal tracks on it in order to define the electrical configuration. In addition, arrays of LEDs are conventionally located so that they are directly in contact with a light guide layer.

There is a continued need for effective methods of producing linear arrays of LEDs which can be effectively optically coupled to the edge of a light guide panel or layer. It is an object of the present invention to provide, inter alia, a light guide device and an LED assembly that addresses one or more of the aforesaid issues.

### SUMMARY OF THE INVENTION

In a first aspect of the present invention, there is provided an edge lit light guide device comprising:

a non-imaging concentrator comprising a light input area and light output area;

an array of LEDs positioned to direct light into the light input area of the non-imaging concentrator;

wherein the non-imaging concentrator is mounted at the edge of a light guide layer.

Advantageously, the non-imaging concentrator forms a single non-imaging concentrator. Advantageously, the non-imaging concentrator and the light guide layer, which may be referred to herein as a core light guide layer, are optically coupled. The light output area of the non-imaging concentrator may be mounted at the edge of the light guide layer. The array of LEDs may be a linear array of LEDs.

The array of LEDs may be mounted onto a substrate. For example, the substrate may be a rigid planar substrate such as a printed circuit board (PCB) or a ceramic tile. Alternatively and advantageously the array of LEDs may form an LED assembly wherein the array of LEDs is mounted on a flexible printed circuit board (flexi-PCB). The LED assembly comprising a flexi-PCB constitutes a further aspect of the present invention. Accordingly, there is provided an LED assembly comprising an array of LEDs mounted on a flexible printed circuit board (flexi-PCB). The LED assembly may also comprise a non-imaging concentrator comprising a light input area and a light output area where the LEDs are positioned to direct light into the light input area of the non-imaging concentrator. The array may be a linear array of LEDs. Typically, the substrate has electrical pads and tracking allowing LEDs to be populated on it.

All of the LED pads and electrical tracking may be located on, or flush with, a first, or upper, surface of the substrate. The substrate may be in contact with a heat sink, for example a heat sink plate or heat spreader which may be made of metal such as aluminium. The substrate may be connected to the heat sink plate or spreader with a suitable adhesive, such as a die-electric thermal adhesive. Heat sink tracks may be located on, or flush with, a second, or lower, surface of the substrate. These heat sink tracks may be made as wide as possible. Typically, each LED is associated with its own heat sink which may be in the form of a track. The LEDs and heat sink tracks may be connected by vias or micro-vias which may be open or filled. The vias (or micro-vias) serve to conduct heat from the LEDs to the heat sink tracks and ultimately to the heat sink.

In the various aspects of the invention, the non-imaging concentrator may be a compound parabolic concentrator (CPC). The light input area and light output area may be a light input surface and a light output surface. For example, the non-imaging concentrator may be a CPC which is injection moulded to form a solid structure thus defining light input and light output surfaces. Alternatively, the light input and output areas may be apertures.

The LEDs may be located in a groove formed at the light input surface of the non-imaging concentrator. The groove may align with the LEDs in the LED array. A compliant optical coupling material such as a gel or similar material may be located in the groove to optically couple the LEDs to the non-imaging concentrator and allow for differential thermal expansion along the length of the LED array. For example, a high refractive index material such as an epoxy resin or a UV curing acrylate resin may be incorporated using micro-dispensing methods thus increasing the optical coupling efficiency between the LED and non-imaging concentrator.

The substrate may comprise alignment features in order to align the non-imaging concentrator with the array of LEDs.

In a further aspect, there is provided a display device comprising the light guide device according to the first aspect of the invention. The display device may be a liquid crystal display device.

There are a number of advantages provided by the present invention. For example, the optical losses are minimised through the use of total internal reflection and it is not necessary to use a metallic reflector to input light to the light guide at the desired angles. The use of a non-imaging concentrator, such as a CPC, means that all of the light rays reaching the output surface or aperture of the CPC after originating from the input surface or aperture are at an angle of less than a well defined cut-off angle from the surface normal of the CPC-light guide core interface. This complete cut-off means that all rays are guided in the core of the light guide, and none are able to be transmitted into the cladding (when present), unless they are scattered by some other means. Thus the combination of a non-imaging concentrator, such as a CPC, with a clad light guide is particularly advantageous.

The flexi-PCB format provides a simple input electrical connection which can be plugged directly into a separate drive PCB. This means that connectivity is easier and may reduce costs. The associated electrical tracking can be a much finer pitch than can be achieved using conventional methods thus facilitating minimisation of the LED pitch. Advantageously, return tracks may only need to be wide enough to carry the drive current, which is typically 50 mA. Heat can be removed directly from the base of the LEDs using open or filled micro-vias connected to thermal (e.g. copper) ground planes or tracks in the bottom layer of the flexi-PCB.

The development of a new array solution is made more rapid since laying out and manufacturing a flexi-PCB design is quicker than, for example, designing and sourcing a new leadframe design. The flexi-PCB format may be re-designed and manufactured within a short timeframe. The flexi-PCB can be made in multiple layers, each potentially carrying electrical tracks, so it is possible to machine top layers of the PCB to form reflective (plated) cavities and achieve electrical connection even if one of the LED electrodes is on its bottom surface. Flexi-PCBs may have layers which are not bonded together. This allows an upper layer to be through-machined and plated and then aligned and bonded to an LED-populated lower layer thus making the machining process easier.

The use of a heat sink, for example a thermally conductive bar, which may be bonded to the base of the flexi-PCB, makes the flexi-PCB suitable for standard LED population and wire-bonding methods. Laser-machining of a cavity and the use of multiple layers can be used to recess the top surface of the LED and/or the wire bonds making the system much less prone to damage as no delicate components such as LEDs and wire-bonds are exposed.

### DETAILED DESCRIPTION OF THE INVENTION

### Light Guide Device

The light guide device may be employed for a range of functions including illumination, backlighting, signage and display purposes. Light from the light source is guided through a light guide layer, typically made of plastic, by total internal reflection. For edge-lit backlighting applications, non-guided light is emitted in a substantially perpendicular direction to that of the direction of propagation of the light within the light guide layer which is typically light transmissive or transparent. This may be achieved through the light being directed so as to interact with scattering structures, such as point defects or films located within or on the surface of the light guide layer.

The coupling of the LED assembly and non-imaging concentrator to the light guide layer may be achieved according to a range of techniques. This may be achieved by a butt joining process where the non-imaging concentrator, which may be formed from an injection moulded polymer, is attached to the end of the light guide by bonding with a transparent adhesive, which may possess a high refractive index, that acts to reduce reflections from the ends of the light guide layer. Preferably, the refractive index of the adhesive is matched to the refractive index of the light guide layer and/or the non-imaging concentrator. Alternatively, the refractive index of the adhesive is between the refractive index of the light guide layer and the non-imaging concentrator. The light guide layer may be hot cleaved, flame-treated or polished to provide a suitable optical surface at the end of the light guide layer which facilitates good coupling of light from the LED array into the light guide layer. Advantageously, the non-imaging concentrator is in direct contact with the light guide layer. Direct contact includes when an adhesive is used.

### Light Guide Layer

The light guide layer (or core light guide layer) may be made from a range of suitable light transmissive or transparent polymer materials. Preferably, the core light guide layer should possess a high optical transmission. Suitable materials for the core include transparent polymers such as pure or blended polymethylmethacrylate (PMMA), polystyrene and other optical polymers. The core light guide layer is, depending on the performance required, typically in the range of about 0.5 mm to 4 mm, for example, about 1 mm or about 1.5 mm in thickness. The refractive index of the core light guide layer may be from about 1.4 to about 1.8, for example about 1.5. There may also be present scattering structures located on the core light guide layer, such as point like defects, to scatter the totally internally reflected light through approximately 90° and in the direction of a main output light surface. Alternatively, the light may be directed in the first instance in the direction of a reflector which reflects the light in the direction of a main light output surface.

The core light guide layer may be sandwiched between the inner surfaces of a first and a second cladding layer. There may also be present: a plurality of scattering structures located at the interface between the first cladding layer and the core light guide layer and/or at the interface between the second cladding layer and the core light guide layer; and, optionally, a series of microlenses arranged on an outer surface of the first cladding layer which is opposite and parallel or substantially parallel to the inner surface of said cladding layer.

The refractive indices of the microlenses and the core light guide layer are typically greater than the refractive indices of the cladding layers. The scattering structures serve to deflect light guided through total internal reflection in the core light guide layer into non-guided directions. Light guided in the core light guide layer is retained within the light guide device and may include light scattered by the scattering structures but not sufficiently scattered to be emitted from the light guide device. Non-guided directions include light which is scattered by the scattering structures through approximately 90° and emitted by the light guide device. The outer surface of the first cladding layer on which the series of microlenses is arranged is the main light output surface. In order for light to be scattered through substantially 90°, in a non-guided direction, and in the direction of the main light output surface, a plurality of scattering structures, for example point defects, may be provided on one of the inner surfaces of the first or second cladding layers and/or on one of the surfaces of the core light guide layer sandwiched between the inner surfaces of the first and second cladding layers. Alternatively, or in addition, the scattering structures may be located within the main body of the core light guide layer. Preferably, each one of the scattering structures has a microlens located directly above it.

The light guide device is arranged to receive light from the LED array and to at least partly constrain light therein by total internal reflection. In particular, the light guide device is suitable for use as an edge lit light guide device and the device further comprises LEDs along one or more edges of the device. The cladding layer between the core light guide layer and the microlenses may be referred to as an intermediate layer. The microlenses are preferably directly in contact with the intermediate layer.

If the core light guide layer has a refractive index n1, the intermediate layer has index n2 and the microlenses have a refractive index n3, then the preferred relationship is n3≧n1>n2. Preferably the ratio of the refractive indices of n1 and n3 to n2 should be as high as possible.

There are numerous advantages associated with the embodiments of the invention which include the intermediate layer and microlenses, these include: improved optical coupling efficiency into a desired range of output angles. Improved optical coupling efficiency reduces the amount of input light required and hence the cost and power consumption of the light sources. The present invention also allows for the output angle to be controlled so the viewing angle can be set accordingly.

### The LED Assembly

The LED assembly may comprise an array of LEDs electrically mounted onto a first surface of a substrate. For example, the substrate may be a rigid planar substrate such as a rigid PCB or a ceramic tile. Alternatively, and advantageously, the array of LEDs may form an LED assembly wherein the array of LEDs is mounted on a flexible printed circuit board (FPC board). The terms flexible PCB, flexi-PCB or FPC are well known in the industry and refer to a pattern of conductors created on a bendable film that acts as an insulating (dielectric) base material. An FPC is a pliable counterpart to a rigid printed circuit board. In connection with the present invention, the principle advantages of an FPC over a rigid PCB are the reduced thickness which maximises the thermal conduction rate to a heat sink on the underside of the FPC and the pliability which allows the FPC to be used in tightly assembled spaces within a final product. Preferably, the flexi-PCB structure is flat or substantially flat at the locations of the LEDs before and after assembly of the LEDs. This flatness facilitates industry-standard automated LED placement and wire-bonding equipment to be used to automatically place and electrically connect a linear array of LEDs to the conductive tracks on the surface of the flexi-PCB.

The light produced by the array of LEDs may be non-directional. In particular, the LEDs are suitable for use in an edge lit arrangement. The LEDs can be any of the designs known to those skilled in the art, including edge-emitting, side emitting, top emitting or bare die LEDs. The LEDs may be selected from one or more of a range of colours. For example, the LEDs may be white. White light may also be generated by combining red, green and blue LEDs. Typically, a bare-die LED suitable for use in the present invention is of the order of about 0.3 mm in each dimension. Advantageously, the flexi-PCB arrangement may support a significant number of LEDs, for example it may support a linear array of 35 to 45 LEDs.

The LED assembly may be aligned with a non-imaging concentrator such as a CPC. There are a number of ways of aligning the LED assembly with the non-imaging concentrator. For example, one way is to mould alignment pins on the non-imaging concentrator and form alignment holes in the substrate (e.g. flexi-PCB) and, if present, the heat sink.

The flexi-PCB may be provided with built in connectivity to external drive circuitry and thermal transfer using vias or micro-vias which may be located directly under or close to the LEDs. Micro-vias are small (machined) holes typically of the order of about 50 μm to about 100 μm in diameter. The vias or micro-vias may be left open or filled with thermally conducting material in order to transfer heat away from the LEDs and into a conductive structure. The micro-vias may be thermally connected to a ground plane or track, for example a copper ground plane on the bottom layer or surface of the flexi-PCB. Light may be captured and redirected using a light reflector which can be bonded to the flexi-PCB. Such an arrangement may be used to capture or redirect any side-emitted light from the LEDs. The flexi-PCB may be machined (e.g. laser machined) or plated to form a reflective chamber. The light reflector may be etched and plated sheet metal or it may be electro-formed. The flexi-PCB may be combined with a thermally conductive structure such as a heat sink. The heat sink may be a rigid thermally conductive bar. The heat sink may be a metal heat sink. Suitable metals include aluminium. The flexi-PCB and thermally conductive structure may be bonded together using thermally conducting material which is also electrically insulating. Suitable examples of bonding material include conductive adhesives (e.g. Bergquist Liqui-bond silicone adhesive) or self-adhesive conductive tapes (e.g. Bergquist Sil-pad).

The LEDs may be located in recesses in the substrate. The flexi-PCB may comprise more than one layer, which may be referred to herein as a multi-layer. For example, the use of a multi-layered flexi-PCB structure allows the LEDs to be recessed. The recesses may be reflective in order to redirect light from the LEDs to improve efficiency. For example, the recesses may be plated, thus forming a reflective chamber. Such a chamber may form a closed cavity within a single flexi-PCB component or the chamber could be through machined into a separate PCB which may then be aligned with the primary LED populated flexi-PCB. Electrical connectivity may be achieved by wire bonding the LEDs to tracks which are inherent in the flexi-PCB format.

Advantageously, there is no requirement for a collimating optic between the LED array and input area of the non-imaging concentrator. Particularly, there may not be present a collimating optic (or light collimator) between the LED array and the non-imaging concentrator.

### Non-Imaging Concentrator

The non-imaging concentrator is an optical component that efficiently transmits light from an input to an output, where the area of the output is greater than the area of the input. Such a component has the effect of reducing the angular divergence of the light at the output compared with that at the input. A suitable example of a non-imaging concentrator is a compound parabolic concentrator (CPC). The CPC may take the form of a shape extruded in the direction of the LED array, and bounded by two shifted and tilted parabolas selected in accordance with the edge ray principle, and by straight input and output surfaces. The form of the parabolic surfaces is such that, if they were perfect reflectors, then 100% of the radiation entering its input aperture, or surface, would fall within the angle and exit aperture, or surface, diameter dictated by the optical invariant. Advantageously, the CPC for use in the present invention uses total internal reflection surfaces, giving 100% reflectivity. The only losses are from material absorption, scattering defects, plus approximately 2% loss from light that does not meet the total internal reflection condition. Thus the CPC is nearly an ideal concentrator. Suitable methods for making the non-imaging concentrator include injection moulding. The non-imaging concentrator may be made from an optical grade polymer such as polymethylmethacylate (PMMA) or polycarbonate (PC).

### Microlenses

Microlenses are small lenses, typically possessing a diameter of about 0.5 to 5 mm. The microlens may comprise hemispheres possessing a diameter of about 2.25 mm or about 4.5 mm. The microlenses may be aspherical in shape. The microlenses may be Fresnel lenses which may have surface features typically of about 0.001 mm to 1 mm in thickness. The refractive index of the microlenses may be about 1.4 to 1.8, for example about 1.6. Suitable materials for the microlenses include polycarbonates, polystyrene or UV curing materials such as a lacquer or an epoxy. The pitch of the lenses may be about 3.1 mm.

The microlens array may be fabricated as a single sheet which may, for example, be injection moulded or formed by a reel to reel thermal embossing technique, or a UV curing reel to reel technique. The overall thickness of such a sheet may typically be about 0.01 mm to 1 mm.

### Cladding Layers

The cladding layers may be made from a range of suitable light transmissive polymer materials. A suitable material for the cladding layers is fluorinated ethylene propylene (FEP). The cladding layers possess lower refractive indices than the core light guide layer and the microlenses. Suitable materials for the cladding layers include transparent polymers such as fluoropolymers. The cladding layers are typically of the order of about 0.01 mm to 0.3 mm in thickness. The refractive index of the cladding layers may be from about 1.25 to about 1.4, for example about 1.35. Advantageously, the ratio of the thickness of the core light guide layer to the thickness of the intermediate layer is greater than about 5.

### Reflector Layer

Light will be scattered in both a first (or upward) direction (towards a main light output surface) and a second (or downward) direction by the scattering structures. It is advantageous to reflect light scattered in the downward direction back in an upward direction using a reflective sheet placed substantially parallel and behind the core light guide layer or, if present, the second cladding layer. The reflective sheet may be attached to the light guide layer or second cladding layer along its main surface. Such a reflective sheet may be made from a metallised polymer film or similar, for example polyethylene terephthalate (PET) possessing a vacuum deposited aluminium layer thereon. The reflective sheet may alternatively be made from a white film or sheet.

### Scattering Structures

In order for light to be scattered through substantially 90°, in a non-guided direction, and in the direction of the main light output surface, a plurality of scattering structures, for example, point defects may be provided on one of the inner surfaces of the first or second cladding layers and/or on one of the surfaces of the core light guide layer which may be sandwiched between the inner surfaces of the first and second cladding layers (if present). Alternatively, or in addition, the scattering structures may be located within the core light guide layer. Preferably, the scattering structures are positioned concentric with the microlenses. The scattering structures may be indents or raised features defined into a surface of the core light guide layer or into a surface of a cladding layer. Alternatively a scattering material such as a pigmented white ink containing TiO₂ particles may be deposited onto a surface of the core light guide layer or a surface of a cladding layer.

### Uses of the Light Guide Device

The light guide device according to the present invention may be employed for a range of functions including illumination, backlighting, signage and display purposes.

Liquid crystal devices are well known in the art. A liquid crystal display device operating in a transmissive mode typically comprises a liquid crystal cell, which may also be referred to as a liquid crystal panel, a backlight unit incorporating a light guide device, and one or more polarisers. Liquid crystal cells are also well known devices.

In general, liquid crystal cells typically comprise two transparent substrates between which is disposed a layer of liquid crystal material. A liquid crystal display cell may comprise two transparent plates which may be coated on their internal faces respectively with transparent conducting electrodes. An alignment layer may be introduced onto the internal faces of the cell in order that the molecules making up the liquid crystalline material line up in a preferred direction. The transparent plates are separated by a spacer to a suitable distance, for example about 2 microns. The liquid crystal material is introduced between the transparent plates by filling the space in between them by flow filling. Polarisers may be arranged in front of and behind the cell. The backlight unit may be positioned behind the liquid crystal cell using conventional means. In operation, a liquid crystal cell, operating in a transmissive mode, modulates the light from a light source such as a backlight unit which may comprise a light guide device.

### BRIEF DESCRIPTION OF THE DRAWINGS

Embodiments of the invention will now be described, by way of example only and without limitation, with reference to the accompanying drawings, in which:

FIG. 1 illustrates a known edge lit light guide device.

FIGS. 2a-2d illustrate an edge lit light guide device in accordance with the present invention.

FIG. 3 illustrates an alternative arrangement for positioning the light source in relation to the non-imaging concentrator.

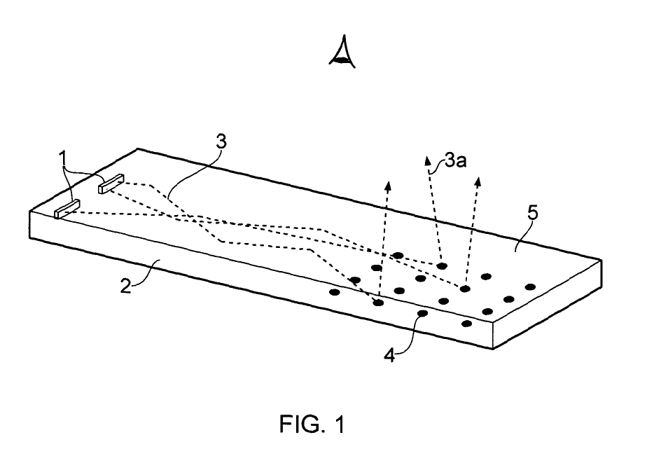

FIG. 1 illustrates a known edge-lit light guide arrangement. LEDs (1) are arranged at the edge of a transparent polymer core light guide layer (2). Light (3) from the LEDs propagates by total internal reflection through the light guide layer and is scattered through approximately 90° by scattering structures, such as point like defects, (4) and exits (3a) the light guide layer. In the figure shown, the device is viewed from above as indicated; the main light output surface is indicated at (5) and the point like defects (4) are located on the opposite lower surface. Typically, the core layer is unclad, relying on the refractive index contrast between the core and surrounding air to provide the guiding effect. Light scattered out of this type of structure is emitted from the top surface over a full hemisphere of output angles.

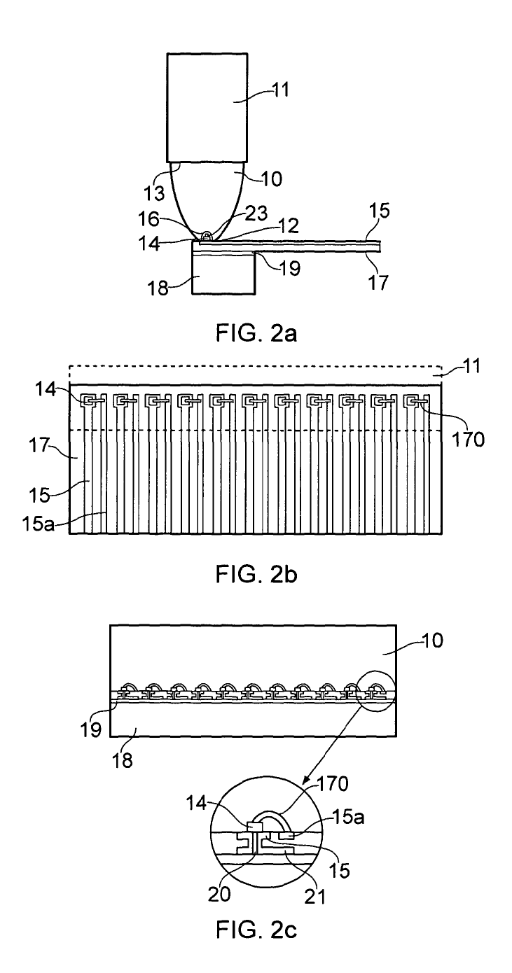

In FIG. 2a, an arrangement in accordance with the present invention is illustrated. A non-imaging concentrator (10) is optically coupled to a light guide layer (11). The non-imaging concentrator has a light input area (12) and a light output area (13) which is shown in contact with the light input surface of the light guide layer (11). In the embodiment shown, the non-imaging concentrator (10) is a CPC which has been injection moulded and has a light input surface (12) and a light output surface (13). An LED (14) is mounted onto a power track (15) and sits in a groove (16) formed in the input surface of the non-imaging concentrator. The groove may be filled with an optically transparent light coupling material (23). The power track (15) is part of the surface layer of a thin PCB structure (17) which may be a flexible printed circuit (FPC) board. The power track (15) is typically thermally connected through the thickness of the PCB structure, through the use of conductive pathways, (which may be micro-vias) to a metal track located on the underside of the thin PCB structure (for example, see feature (21) in FIG. 2c). This metal track is in turn thermally connected to a heat sink (18), or heat spreader, with, for example, dielectric thermal adhesive (19).

A plan view of a possible power track arrangement is shown in FIG. 2b and an end view in FIG. 2c. In FIG. 2b the LEDs are shown mounted on parallel tracks (15) and are wire bonded (170) to adjacent return tracks (15a) using conventional wire bonding equipment.

FIG. 2c also shows a magnified view of a part of the device. An LED (14) is shown mounted on a power track (15) and a wire bond (170) between power and return tracks (15, 15a). Directly underneath the LED (14) is located a via or micro-via (20) which assists in transferring heat to a metal track or heat sink track (21).

In FIG. 2d, an end mounted LED (14), in relation to the non-imaging concentrator (10), is shown mounted on a rigid planar substrate such as a PCB (17b). A groove (16) is formed in the non-imaging concentrator (10). A compliant optical coupling gel (23) is used to optically couple the LEDs to the CPC and allow for differential thermal expansion along the length of the LED array. Alternatively, a high refractive index material such as an epoxy resin or a UV curing acrylate resin may be incorporated using micro-dispensing methods thus increasing the optical coupling efficiency between the LED and CPC.

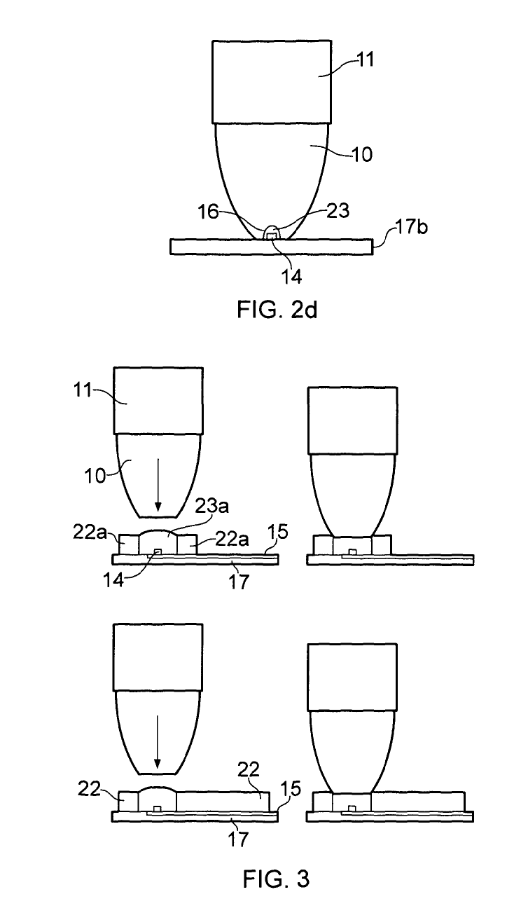

In FIG. 3, an alternative arrangement for mounting and/or aligning the non-imaging concentrator (10) on the light source (14) is shown. An additional PCB layer (22) (or a separate injection moulded part—22a) is attached to the flexi-PCB (17) forming a channel around the LEDs (14) and the wire bonds. An optically transparent complaint material (23a) is potted into the channel formed by the additional PCB layer (22) in order to provide an effective optical coupling to the CPC. The additional PCB or moulded part may also help to align the CPC to the LEDs.

1. An edge-lit light guide device comprising:
a non-imaging concentrator comprising a light input area and a light output area; and
an array of LEDs positioned to direct light into the light input area of the non-imaging concentrator;
wherein said non-imaging concentrator is optically coupled to a core light guide layer.

2. An edge-lit light guide device according to claim 1 wherein the non-imaging concentrator is a compound parabolic concentrator (CPC).

3. An edge-lit light guide device according to claim 1, wherein the non-imaging concentrator is made from a transparent polymer.

4. An edge-lit light guide device according to claim 3 wherein the non-imaging concentrator is made from a pure or blended polymethylmethacrylate or polycarbonate.

5. An edge-lit light guide device according to claim 1, further comprising scattering structures on the core light guide layer to scatter light from the array of LEDs in the direction of a light output surface of the core light guide layer.

6. An edge-lit light guide device according to claim 1, wherein the core light guide layer is sandwiched between the inner surfaces of a first cladding layer and a second cladding layer.

7. An edge-lit light guide device according to claim 6 wherein:
a plurality of scattering structures is located at one or more of the following: at an interface between the first cladding layer and the core light guide layer, at an interface between the second cladding layer and the core light guide layer, and within the core light guide layer;
a series of microlenses is arranged on an outer surface of the first cladding layer wherein said outer surface is opposite the inner surface of the first cladding layer; and
refractive indices of the microlenses and the core light guide layer are greater than refractive indices of the cladding layers.

8. An edge-lit light guide device according to claim 7, wherein:
the plurality of scattering structures is located at one or more of the following: at the interface between the first cladding layer and the core light guide layer, at the interface between the second cladding layer and the core light guide layer;
the microlenses are located directly above the plurality of scattering structures;
the refractive indices of the microlenses and the core light guide layer are substantially the same.

9. An edge-lit light guide device according to claim 8, wherein the refractive indices of the microlenses and the core light guide layer are from about 1.4 to about 1.8 and the refractive indices of the first and second cladding layers are from about 1.25 to about 1.4.

10. An edge-lit light guide device according to claim 1, wherein the array of LEDs is a linear array.

11. An edge-lit light guide device according to claim 1, wherein the array of LEDs comprises LEDs located on a first surface of a substrate and being electrically connected to the substrate.

12. An edge-lit light guide device according to claim 11, wherein the substrate is a flexible printed circuit board (flexi-PCB).

13. An edge-lit light guide device according to claim 12, further comprising a heat sink.

14. An edge-lit light guide device according to claim 13, wherein micro-vias are located between one or more of the LEDs in the array of LEDs and the heat sink and provide a thermal path between one or more of the LEDs and the heat sink.

15. An edge-lit light guide device according to claim 14, wherein the micro-vias are filled with thermally conducting material.

16. An edge-lit light guide device according to claim 1, wherein the core light guide layer is a transparent polymer.

17. An edge-lit light guide device according to claim 12, wherein the array of LEDs is located in recesses in the flexi-PCB.

18. An edge-lit light guide device according to claim 17, wherein the recesses are at least partially coated with a light reflecting material.

19. An LED assembly for a light guide device, wherein said assembly comprises an array of LEDs mounted on a flexible PCB substrate.

20. An LED assembly according to claim 19, wherein the flexible PCB substrate is connected to a heat sink.

21. An LED assembly according to claim 20, further comprising micro-vias located between the LEDs in the array of LEDs and the heat sink and which provide a thermal path between the LEDs and the heat sink.

22. An LED assembly according to claim 19, wherein the LEDs in the array of LEDs are located in recesses in the flexible PCB substrate.

23. An LED assembly according to claim 22, wherein the recesses are light reflective.

24. A display device comprising a light guide device comprising:
a non-imaging concentrator comprising a light input area and a light output area; and
an array of LEDs positioned to direct light into the light input area of the non-imaging concentrator;
wherein said non-imaging concentrator is optically coupled to a core light guide layer.

25. An edge-lit light guide device according to claim 1, wherein the light guide device is disposed in a display device which is a liquid crystal device.
